(19) United States
(12) Patent Application Publication
(10) Pub. No.: US 2010/0057355 A1
(43) Pub. Date: Mar. 4, 2010

(54) LOCATION IDENTIFICATION

(76) Inventors: Gene Fein, Malibu, CA (US); Edward Merritt, Lenox, MA (US)

Correspondence Address: FOLEY & LARDNER LLP, 150 EAST GILMAN STREET, P.O. BOX 1497, MADISON, WI, 53701-1497, US

(21) Appl. No.: 12/200,397

(22) Filed: Aug. 28, 2008

(51) Int. Cl. G01C 21/34

(52) U.S. Cl. 701/209; 701/207; 701/208

(57) ABSTRACT

A device includes a processor and a computer-readable medium including computer-readable instructions. Upon execution by the processor, the computer-readable instructions cause the device to receive a first request from a second device, where the first request is for an identification of a location. The first request includes vehicle information. The computer-readable instructions also cause the device to provide a second request to a third device, where the second request includes the vehicle information. The computer-readable instructions further cause the device to receive the identification of the location from the third device, and provide the identification of the location to the second device.

### BACKGROUND

Global positioning system (GPS) technology can refer to a satellite-based positioning technology that allows a GPS receiver to identify its current location. The location can be identified in terms of longitudinal and latitudinal coordinates. The location may be determined through the use of triangulation, which is a mathematical process that utilizes known locations and distances to determine an unknown location. Global positioning system technology has many applications, including military, sports, and vehicular navigation. In addition to GPS, satellites can also be used to gather satellite imagery. Satellite imagery can refer to digital data which is obtained using one or more sensor on a satellite. The one or more sensor can include a camera, a laser, radar, etc.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a block diagram of a location identification system in accordance with an illustrative embodiment.

FIG. 2 depicts a block diagram of a user computing device of the location identification system of FIG. 1 in accordance with an illustrative embodiment.

FIG. 3 depicts a block diagram of a middleware system of the location identification system of FIG. 1 in accordance with an illustrative embodiment.

FIG. 4 depicts a block diagram of a cloud computing system of the location identification system of FIG. 1 in accordance with an illustrative embodiment.

FIG. 5 depicts a flow diagram illustrating operations performed by the cloud computing system of FIG. 4 in accordance with an illustrative embodiment.

FIG. 6 depicts a flow diagram illustrating operations performed by the user computing device of FIG. 2 in accordance with an illustrative embodiment.

FIG. 7 depicts a flow diagram illustrating operations performed by the middleware system of FIG. 3 in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Illustrative systems, methods, devices, computer-readable media, etc. are described for identifying a location. In an illustrative embodiment, the location can be identified using a middleware system and a cloud computing system. The middleware system, which can be used in part to facilitate communication between the cloud computing system and a user computing device, can receive a request to identify a location in proximity to the user computing device or a point of interest. The middleware system can provide the received request to the cloud computing system. The cloud computing system can receive information regarding a current position of the user computing device, a type of the location, and information related to one or more potential location. The cloud computing system can also identify one or more location to satisfy the request, and provide the one or more identified location to the middleware system. The middleware system can provide the one or more identified location to the user computing device. As such, the cloud computing system can be used to perform the processor intensive computations associated with identifying and updating requested locations.

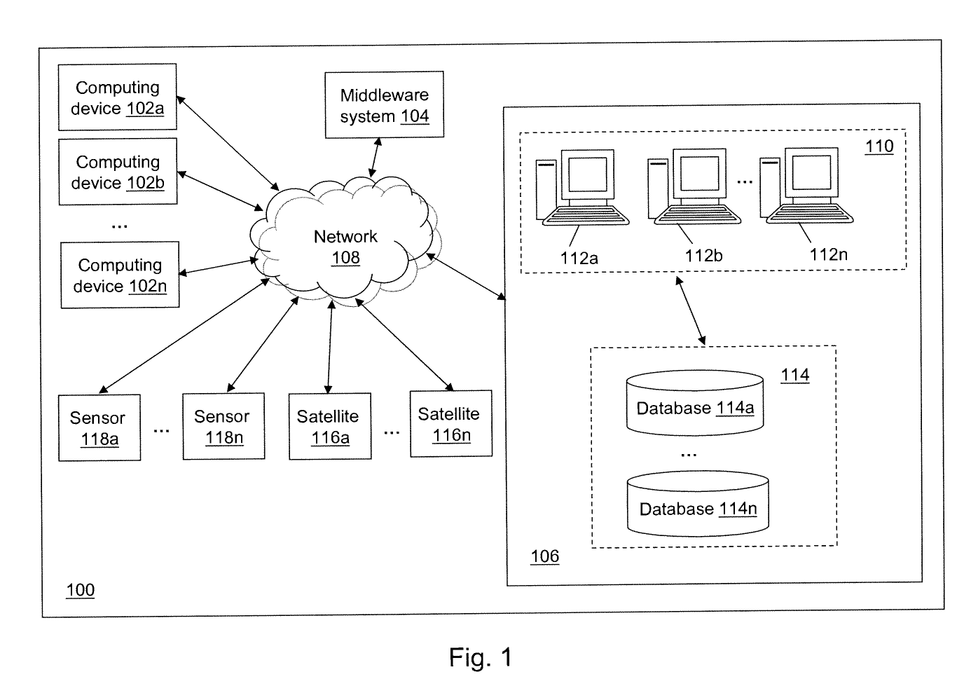

With reference to FIG. 1, a block diagram of a location identification system 100 is shown in accordance with an illustrative embodiment. Location identification system 100 can include one or more user computing devices 102a, 102b, . . . , 102n, one or more satellites 116a, . . . , 116n, one or more sensors 118a, . . . , 118n, a middleware system 104, and a cloud computing system 106. The one or more user computing devices 102a, 102b, . . . , 102n may be a computer of any form factor including a portable global positioning system (GPS) device, an in-dash GPS device, a vehicular information system such as OnStar™, a laptop, a desktop, a server, an integrated messaging device, a personal digital assistant, a cellular telephone, an iPod, etc. The one or more satellites 116a, . . . , 116n can be GPS satellites and/or imaging satellites as known to those of skill in the art.

The one or more satellites 116a, . . . , 116n can be any type of satellite known to those of skill in the art. The one or more satellites 116a, . . . , 116n may be equipped with receivers, transmitters, and/or digital imaging devices such as digital cameras, digital camcorders, radar devices, laser devices, etc. The one or more sensors 118a, . . . , 118n can be used to convey information regarding the availability of locations such as parking spaces. The one or more sensors 118a, . . . , 118n can determine availability based on a sensed mass, based on a sensed obstruction, based on a determination that a given parking facility/garage is at capacity, based on a sensed status of a parking meter, etc. The one or more sensors 118a, . . . , 118n can be any type of sensors known to those of skill in the art. The devices associated with the one or more user computing devices 102a, 102b, . . . , 102n, the one or more satellites 116a, . . . , 116n, the one or more sensors 118a, . . . , 118n, middleware system 104, and cloud computing system 106 may communicate with each other using a network 108.

Network 108 may include one or more type of network including a cellular network, a peer-to-peer network, the Internet, a local area network, a wide area network, a Wi-Fi network, a Bluetooth™ network, etc. Cloud computing system 106 can include one or more servers 110 and one or more databases 114. A cloud computing system refers to one or more computational resources accessible over a network to provide users on-demand computing services. The one or more servers 110 can include one or more computing devices 112a, 112b, . . . , 112n which may be computers of any form factor. The one or more databases 114 can include a first database 114a, . . . , and an nth database 114n. The one or more databases 114 can be housed on one or more of the one or more servers 110 or may be housed on separate computing devices accessible by the one or more servers 110 directly through wired or wireless connection or through network 108. The one or more databases 114 may be organized into tiers and may be developed using a variety of database technologies without limitation. The components of cloud computing system 106 may be implemented in a single computing device or a plurality of computing devices in a single location, in a single facility, and/or may be remote from one another. The one or more satellites 116a, . . . , 116n and the one or more sensors 118a, . . . , 118n can communicate with middleware system 104 and/or cloud computing system 106 through network 108. Alternatively, the one or more satellites 116a, . . . , 116n and the one or more sensors 118a, . . . , 118n can communicate directly with middleware system 104 and/or cloud computing system 106.

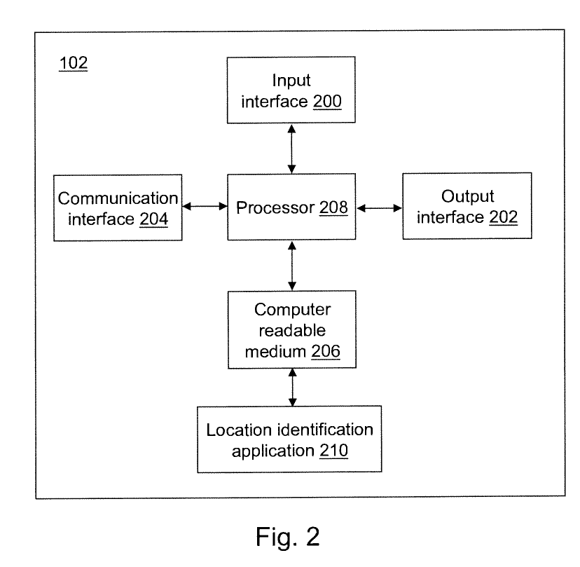

With reference to FIG. 2, a block diagram of a user computing device 102 of location identification system 100 is shown in accordance with an illustrative embodiment. User computing device 102 can include an input interface 200, an output interface 202, a communication interface 204, a computer-readable medium 206, a processor 208, and a location identification application 210. Different and additional components may be incorporated into user computing device 102 without limitation. Location identification application 210 provides a graphical user interface with user selectable and controllable functionality. Location identification application 210 may include a browser application or other user interface based application that interacts with middleware system 104 to allow a user to send a request for the identification of a location, to specify a type of the location, to provide information regarding a vehicle in which user computing device 102 is located, to receive the identification of a requested location, and/or to receive updates regarding the identification of the requested location.

Input interface 200 provides an interface for receiving information from the user for entry into user computing device 102 as known to those skilled in the art. Input interface 200 may interface with various input technologies including, but not limited to, a keyboard, a pen and touch screen, a mouse, a track ball, a touch screen, a keypad, one or more buttons, etc. to allow the user to enter information into user computing device 102 or to make selections presented in a user interface displayed using a display under control of location identification application 210. Input interface 104 may provide both an input and an output interface. For example, a touch screen both allows user input and presents output to the user. User computing device 102 may have one or more input interfaces that use the same or a different interface technology.

Output interface 202 provides an interface for outputting information for review by a user of user computing device 102. For example, output interface 202 may include an interface to a display, a printer, a speaker, etc. The display may be any of a variety of displays including, but not limited to, a thin film transistor display, a light emitting diode display, a liquid crystal display, etc. The printer may be any of a variety of printers including, but not limited to, an ink jet printer, a laser printer, etc. User computing device 102 may have one or more output interfaces that use the same or a different interface technology.

Communication interface 204 provides an interface for receiving and transmitting data between devices using various protocols, transmission technologies, and media. The communication interface may support communication using various transmission media that may be wired or wireless. User computing device 102 may have one or more communication interfaces that use the same or different protocols, transmission technologies, and media.

Computer-readable medium 206 is an electronic holding place or storage for information so that the information can be accessed by processor 208. Computer-readable medium 206 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disk (CD), digital versatile disk (DVD), . . . ), smart cards, flash memory devices, etc. User computing device 102 may have one or more computer-readable media that use the same or a different memory media technology. User computing device 102 also may have one or more drives that support the loading of a memory media such as a CD, a DVD, a flash memory card, etc.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with input interface 200, with output interface 202, with communication interface 204, and with computer-readable medium 206 to receive, to send, and to process information. Processor 208 may retrieve a set of instructions from a permanent memory device and copy the instructions in an executable form to a temporary memory device that is generally some form of RAM. User computing device 102 may include a plurality of processors that use the same or a different processing technology.

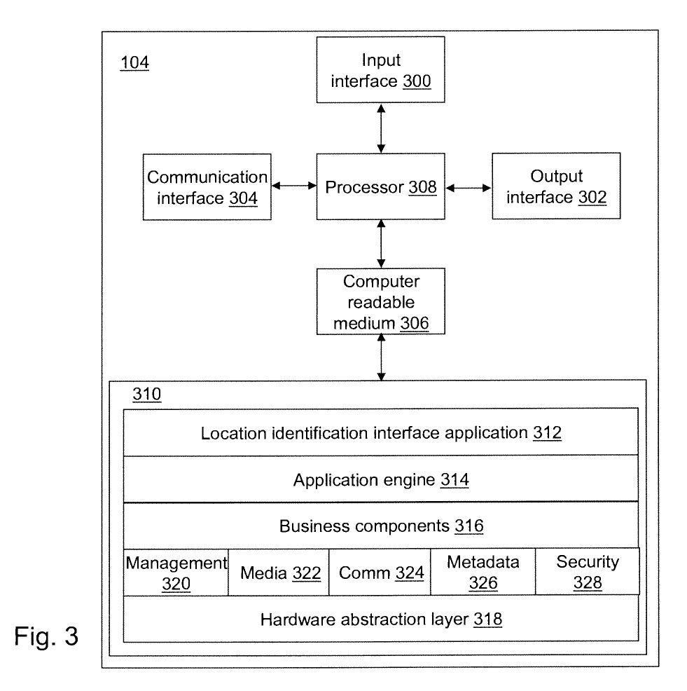

With reference to FIG. 3, a block diagram of middleware system 104 of location identification system 100 is shown in accordance with an illustrative embodiment. Middleware system 104 can include an input interface 300, an output interface 302, a communication interface 304, a computer-readable medium 306, a processor 308, and location identification architecture 310. Different and additional components may be incorporated into middleware system 104 without limitation. For example, middleware system 104 may include a database that is directly accessible by middleware system 104 or accessible by middleware system 104 using a network. Middleware system 104 may further include a cache for temporarily storing information communicated to middleware system 104. Input interface 300 provides similar functionality to input interface 200. Output interface 302 provides similar functionality to output interface 202. Communication interface 304 provides similar functionality to communication interface 204. Computer-readable medium 306 provides similar functionality to computer-readable medium 206. Processor 308 provides similar functionality to processor 208.

Location identification architecture 310 can include a location identification interface application 312, an application engine 314, business components 316, and a hardware abstraction layer 318. Location identification interface application 312 includes the operations associated with interfacing between cloud computing system 106, user computing device 102, the one or more satellites 116a, . . . , 116n, and/or the one or more sensors 118a, . . . , 118n to process a request for the identification of a location and to deliver one or more identified locations to user computing device 102. Location identification architecture 310 includes functionality to support space finder, map to available space(s), percent chance of obtaining space(s), cost estimator, walk estimator, space size estimation, space details, etc. Location identification architecture 310 can be utilized by crane operators to stack shipping crates, either via the tagging of crates or via a scan of the available area to load the crates into, the area being pre-mapped into a grid, and matched against the grid via the scan. Location identification architecture 310 can be utilized by baggage handlers in cargo holds. The cost estimator function consider whether the parking space is free or metered or whether there are garage fees. The walk estimator function estimate how long it will take to walk from the space to a destination. The space size estimation function determines the size of the space in relation to the size of the vehicle to determine the remaining space. The space details function alerts the user to specific parking space parameters such as time limitations, no overnight parking, etc.

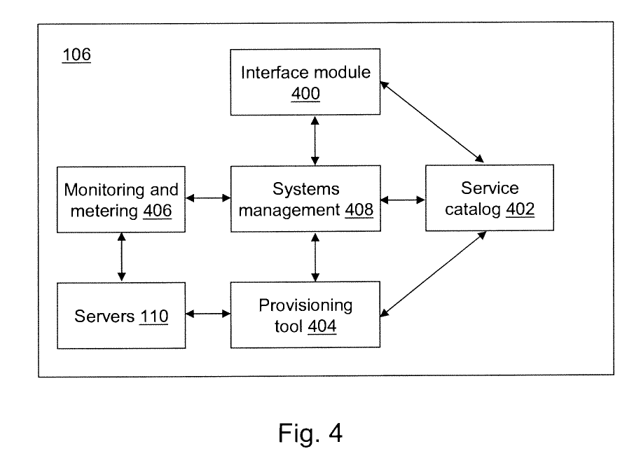

With reference to FIG. 4, a block diagram of modules associated with cloud computing system 106 of location identification system 100 is shown in accordance with an illustrative embodiment. Cloud computing system 106 can include an interface module 400, a service catalog 402, a provisioning tool 404, a monitoring and metering module 406, a system management module 408, and the one or more servers 110. Different and additional components may be incorporated into cloud computing system 106 without limitation. For example, cloud computing system 106 may further include the one or more databases 114. Middleware system 104 interacts with interface module 400 to request services. Service catalog 402 provides a list of services that middleware system 104 can request. Provisioning tool 404 allocates computational resources from the one or more servers 110 and the one or more databases 114 to provide the requested service and may deploy information to the one or more servers 110 for use in generating an identification of a location. Monitoring and metering module 406 tracks the usage of the one or more servers 110 so the resources used can be attributed to a certain user possibly for billing purposes. System management module 408 manages the one or more servers 110. The one or more servers 110 can be interconnected as if in a grid running in parallel.

Interface module 400 may be configured to allow selection of a service from service catalog 402. A request associated with a selected service may be sent to system management module 408. System management module 408 identifies an available resource(s) such as one or more of servers 110 and/or one or more of databases 114. System management module 408 calls provisioning tool 404 to allocate the identified resource(s). Provisioning tool 404 may deploy a requested stack or web application as well.

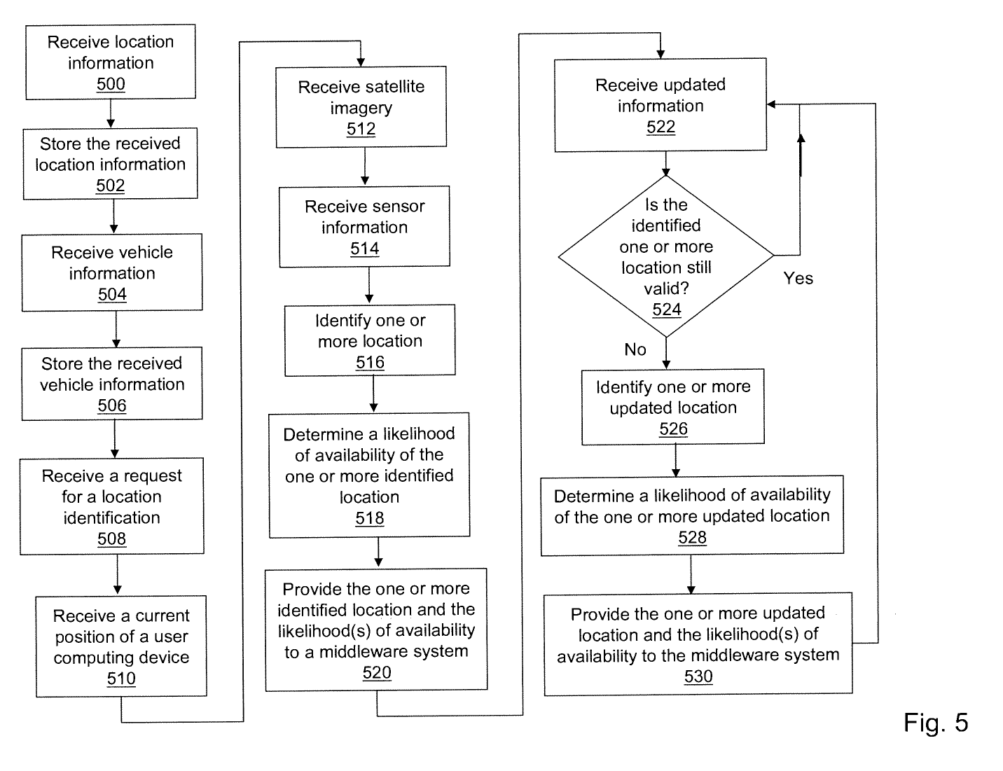

With reference to FIG. 5, illustrative operations performed by cloud computing system 106 are described. Additional, fewer, or different operations may be performed, depending on the embodiment. The order of presentation of the operations of FIG. 5 is not intended to be limiting. In an operation 500, location information is received. The location information can include global positioning system (GPS) coordinates (or other coordinates) corresponding to locations of interest. In an illustrative embodiment, the locations of interest can be parking spaces. The locations of interest may also be street vendor locations, docking spaces, loading zones, etc. The location information can also include time of day/year information corresponding to the locations of interest. The time of day/year information can include times of limited parking (i.e., 2 hour parking from 8:00 am-12:00 pm), times of no parking (i.e., no parking from 12:00 pm-1:00 pm), loading zone restrictions (i.e., loading zone only from 4:00 pm-5:00 pm), overnight parking restrictions (i.e., no overnight parking), winter parking restrictions (i.e., even/odd side of the road parking only), etc. The location information can further include traffic light patterns in proximity to the locations of interest, traffic patterns in proximity to the locations of interest, traffic volume in proximity to the locations of interest, event information (i.e., concert, parade, block party, etc.) in proximity to the locations of interest, etc. The location information can be received from middleware system 104 and/or from any other source. In an operation 502, the received location information is stored. The received location can be stored in the one or more databases 114, or in any other storage location.

In an operation 504, vehicle information is received. The vehicle information can include a make, model, year, length, width, height, turning radius, etc. of a vehicle in which user computing device 102 is located. If user computing device 102 is a portable device, the vehicle information can include information corresponding to a plurality of vehicles in which user computing device 102 may be placed. In an illustrative embodiment, the vehicle information may be received from middleware system 104. The vehicle information may also be received from other sources. For example, middleware system 104 may provide the make, model, and/or year of a vehicle in which user computing device 102 is installed. Cloud computing system 106 may use the make, model, and/or year of the vehicle to obtain additional vehicle information such as vehicle dimensions, etc. from another source. In an operation 506, the received vehicle information is stored. The received vehicle information can be stored in the one or more databases 114, or in any other storage location.

In an operation 508, a request for a location identification is received. The request can be received from middleware system 104. If user computing device 102 is a portable device that is associated with more than one vehicle, the request can include can include a vehicle identification. In an operation 510, a current position of user computer device 102 is received. The current position can be received from middleware system 104 and/or from the one or more satellites 116a, . . . , 116n, depending on the embodiment. In one embodiment, the current position can be received along with the request for the location identification in operation 508. In an alternative embodiment, a point of interest may be received in addition to or instead of the current position. For example, the point of interest may be a restaurant, and the request for the location identification may be for a parking space in proximity to the restaurant.

In an operation 512, satellite imagery is received. The satellite imagery can include one or more digital image, one or more digital video, coordinates, etc. of locations in proximity to user computing device 102 and/or a received point of interest. The satellite imagery can also include information regarding current traffic volume and events. The satellite imagery can be received directly from the one or more satellites 116a, . . . , 116n, or from middleware system 104, depending on the embodiment. In an illustrative embodiment, the satellite imagery can be used in determining the availability of the requested location.

In an operation 514, sensor information is received. The sensor information can be received directly from the one or more sensors 118a, . . . , 118n, from middleware system 104, and/or from another intermediate source. The sensor information can include information received from one or more sensor from a parking ramp/garage or valet service regarding the number, location, etc. of available parking spots. The sensor information can also include information from sensors embedded in a parking meter, embedded in a curb adjacent to a parking space, and/or embedded in the parking space.

In an operation 516, one or more location is identified. The one or more location can be identified based on the location information, the vehicle information, the current position of user computing device 102, the satellite imagery, and/or the sensor information. As an example with respect to the location information, the identification of the one or more location can be based on time of day/year restrictions which affect the location, the traffic volume, a known size of the location, etc. As an example with respect to the vehicle information, the identification of the one or more location can be based on a length, width, height, turning radius, etc. of the vehicle in which user computing device 102 is located. As an example with respect to the current position, the identification of the one or more location can be based on a distance between user computing device 102 and a potential location and/or an estimated time for user computing device 102 to arrive at the potential location. As an example with respect to the satellite imagery, the identification of the one or more location can be based on a visual verification that a location is available. The identification of the one or more location can also be based on images of other vehicles which are in proximity to a potential location (i.e., are the other vehicles within the lines of adjacent parking spots, etc.) As an example with respect to the sensor information, the identification of the one or more location can be based on a signal indicating that a parking meter is expired, on a signal that a parking ramp/garage is full or has available parking spaces, and/or on a signal that a vehicle is present in the parking space. The identification of the one or more location can also be based on a sensed actual size of a parking spot based on the positions of vehicles in adjacent parking spots.

In an operation 518, a likelihood of availability for each of the one or more identified location is determined. The likelihood of availability can refer to the likelihood that an identified location will still be available when user computing device 102 arrives at the identified location. The likelihood of availability can be based on the distance between user computing device 102 and the identified location, an estimated amount of time for user computing device 102 to reach the identified location, a stored estimate of traffic volume, real time traffic volume, a number of available locations in the vicinity, etc. In an operation 520, the one or more identified location and the likelihood(s) of availability are provided to middleware system 104.

In an operation 522, updated information is received. The updated information can include an updated current position of user computing device 102, updated location information, updated vehicle information, updated current position, updated satellite imagery, updated sensor information, etc. In an operation 524, a determination is made regarding whether the identified one or more location is still valid. The determination can be based on the updated information received in operation 522 and can include any of the determinations made during the identification of the one or more location in operation 516. If it is determined that the one or more location is still valid, cloud computing system 106 can continue to receive updated information in operation 522 and determine whether the identified one or more location is still valid in operation 524.

If it is determined that the one or more location is no longer valid (i.e., another vehicle has parked in the parking space, the road has become closed, etc.), one or more updated location is identified in an operation 526. In an operation 528, a likelihood(s) of availability of the one or more updated location is determined. The likelihood(s) of availability of the one or more updated location can be determined based on the received updated information according to any of the methods used to determine the likelihood(s) of availability in operation 518. In an operation 530, the one or more updated location and the likelihood(s) of availability are provided to middleware system 104. As indicated by the arrow between operations 530 and 522, cloud computing system 106 can continue to iterate operations 522-530 until user computing device 102 successfully arrives at an identified location.

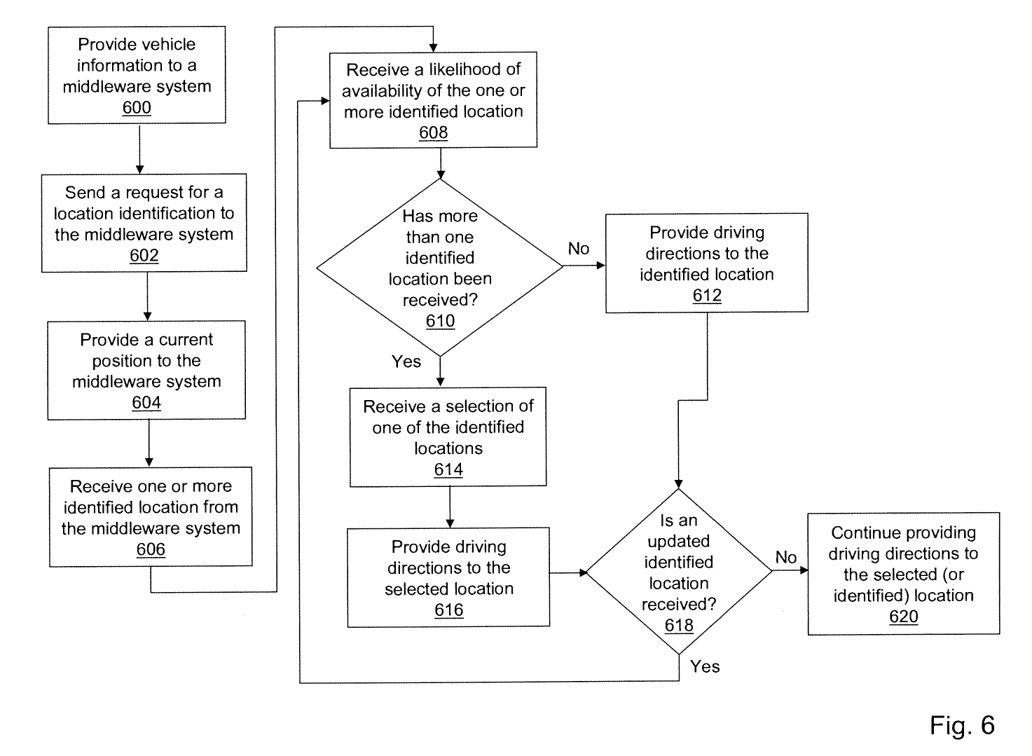

With reference to FIG. 6, illustrative operations performed by user computing device 102 are described. Additional, fewer, or different operations may be performed, depending on the embodiment. The order of presentation of the operations of FIG. 6 is not intended to be limiting. In an operation 600, vehicle information is provided to middleware system 104. The vehicle information can include any of the vehicle information described with reference to FIG. 5. In an operation 602, a request for a location identification is sent to middleware system 104. In one embodiment, the request for the location identification can include the vehicle information.

In an operation 604, a current position of user computing device 102 is provided to middleware system 104. In an illustrative embodiment, the current position of user computing device 102 can be intermittently or continually provided to middleware system 104 such that middleware system 104 and cloud computing system 106 have up-to-date information. In one embodiment, the request for the location identification can include an initial current position of user computing device 102. In an operation 606, one or more identified location is received from middleware system 104. In an operation 608, a likelihood(s) of availability is received for each of the one or more identified location.

In an operation 610, a determination is made regarding whether more than one identified location has been received. If it is determined that there is not more than one identified location, driving directions are provided to the identified location in an operation 612. User computing device 102 can obtain the driving directions using satellites 116a, . . . , 116n and standard GPS algorithms, or by any other method known to those of skill in the art. If more than one identified location has been received, a selection of one of the identified locations is received in an operation 614. The selection can be based on the received likelihoods of availability, user preference, etc. The selected identified location may be provided to middleware system 104 for provision to cloud computing system 106 such that cloud computing system 106 can provide accurate updates. In an operation 616, driving directions are provided to the selected location. The driving directions can be provided through output interface 202. In an alternative embodiment, driving directions may automatically be provided to an identified location having a highest likelihood of availability, and the selection may not be received.

In an operation 618, a determination is made regarding whether an updated identified location is received from middleware system 104. If an updated identified location is not received, user computing device 102 can continue to provide driving directions to the selected (or identified) location in an operation 620. If an updated identified location is received, user computing device 102 can perform operations 608-616 with respect to the updated identified location.

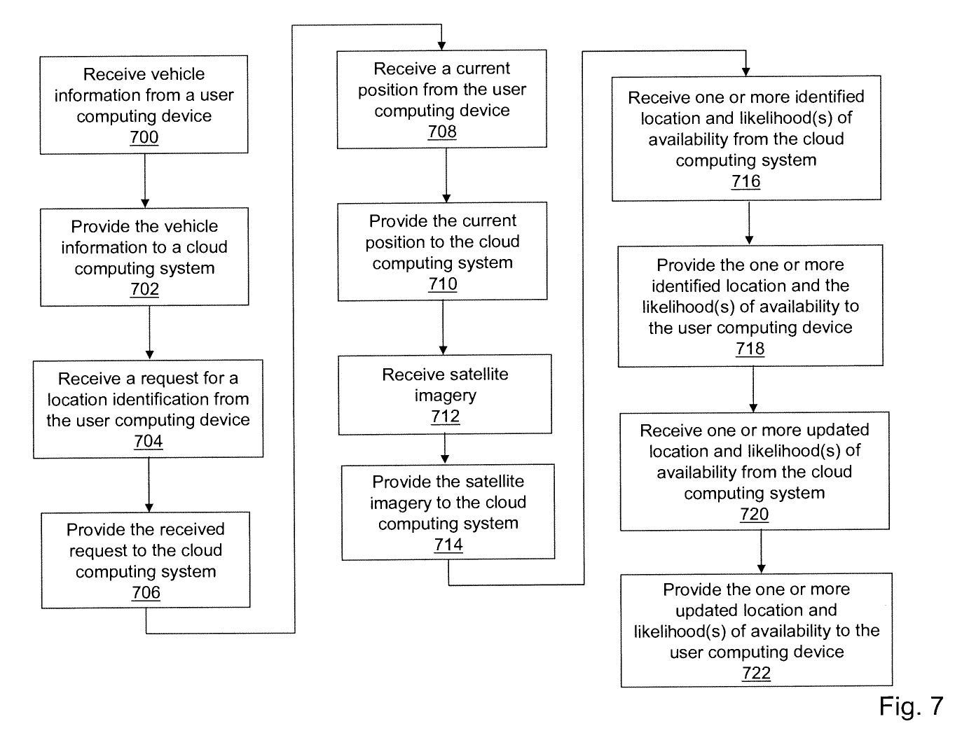

With reference to FIG. 7, illustrative operations performed by middleware system 104 are described. Additional, fewer, or different operations may be performed, depending on the embodiment. The order of presentation of the operations of FIG. 7 is not intended to be limiting. Middleware system 104 defines the parameters for returning identified locations, updated identified locations, likelihoods of availability, etc. to user computing device 102 using application programming interfaces, for example associated with operating system compatibility, display capability, etc. Middleware system 104 further defines similar parameters for interacting with cloud computing system 106.

In an operation 700, vehicle information is received from user computing device 102. In an operation 702, the vehicle information is provided to cloud computing system 106. In an operation 704, a request for a location identification is received from user computing device 102. In an operation 706, the received request is provided to cloud computing system 106. In an operation 708, a current position is received from user computing device 102, and in an operation 710 the current position is provided to cloud computing system 106. In an operation 712, satellite imagery is received, and in an operation 714, the satellite imagery is provided to cloud computing system 106. In one embodiment, location information and/or sensor information may also be received by middleware system 104 for provision to cloud computing system 106. Alternatively, the satellite imagery, location information, and/or sensor information may be provided directly to cloud computing system 106 from the one or more satellites 116a, . . . , 116n, the one or more sensors 118a, . . . , 118n, or some other source. In one embodiment, the location information, satellite imagery, and/or sensor information can be requested by middleware system 104 in response to the received request for the location identification. Alternatively, cloud computing system 106 may directly request the information or request that middleware system 104 obtain the information.

In an operation 716, one or more identified location and corresponding likelihood(s) of availability are received from cloud computing system 106. In an operation 718, the one or more identified location and the likelihood(s) of availability are provided to user computing device 102. In an operation 720, one or more updated location and likelihood(s) of availability may be received from cloud computing system 106, and in an operation 722 the one or more updated location and likelihood(s) of availability are provided to user computing device 102.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device comprising:
a processor; and
a computer-readable medium including computer-readable instructions that, upon execution by the processor, cause the device to
receive a first request from a second device, wherein the first request is for an identification of a location, and further wherein the first request includes vehicle information;
provide a second request to a third device, wherein the second request includes the vehicle information;
receive the identification of the location from the third device; and
provide the identification of the location to the second device.

2. The device of claim 1, wherein the first request further includes a point of interest, and further wherein the location is in proximity to the point of interest.

3. The device of claim 1, wherein the computer-readable instructions further cause the device to:
receive a satellite image; and
provide the satellite image to the third device;
wherein the identification of the location is based at least in part on the satellite image.

4. The device of claim 3, wherein the satellite image identifies a vacant parking space, and further wherein the location is the vacant parking space.

5. The device of claim 3, wherein the satellite image identifies traffic volume in proximity to the location.

6. The device of claim 1, wherein the computer-readable instructions further cause the device to:
receive sensor information; and
provide the sensor information to the third device;
wherein the identification of the location is based at least in part on the sensor information.

7. The device of claim 6, wherein the sensor information indicates whether a parking meter associated with the location is expired.

8. The device of claim 6, wherein the sensor information identifies a vacant parking space in one or more of a parking garage, a parking ramp, and a valet parking facility.

9. The device of claim 1, further comprising a location identification interface application configured to provide an interface between the device and the second device and between the device and the third device, wherein the second device uses a first operating system and the third device uses a second operating system.

10. A system comprising:
a first device comprising
a first processor; and
a first computer-readable medium including first computer-readable instructions that, upon execution by the first processor, cause the first device to
receive a first request from a second device, wherein the first request is for an identification of a location, and further wherein the first request includes vehicle information;
provide a second request to a third device, wherein the second request includes the vehicle information;
receive the identification of the location from the third device; and
provide the identification of the location to the second device; and
the third device comprising
a second processor; and
a second computer-readable medium including second computer-readable instructions that, upon execution by the second processor, cause the third device to
receive the second request from the first device;
generate the identification of the location based at least in part on the vehicle information; and
provide the identification of the location to the first device.

11. The system of claim 10, wherein the second device comprises a global positioning system (GPS) that is configured to provide driving directions to the location.

12. The system of claim 10, wherein the second computer-readable instructions further cause the third device to receive a current position of the second device, wherein the identification of the location is based at least in part on the current position.

13. The system of claim 10, wherein the second computer-readable instructions further cause the third device to receive sensor information, wherein the identification of the location is based at least in part on the sensor information.

14. The system of claim 10, wherein the second computer-readable instructions further cause the third device to receive a satellite image, wherein the identification of the location is based at least in part on the satellite image.

15. The system of claim 10, wherein the second computer-readable instructions further cause the third device to:
determine a likelihood of availability of the location; and
provide the likelihood of availability to the first device.

16. The system of claim 15, wherein the likelihood of availability is based at least in part on a current position of the second device.

17. A method for identifying locations, the method comprising:
receiving a request at a third device from a first device, wherein the request is for an identification of a location, and further wherein the request includes a current position of a second device;
receiving a satellite image of an area that includes the current position of the second device;
generating the identification of the location based at least in part on the current position of the second device and at least in part on the satellite image; and
providing the identification of the location to the first device.

18. The method of claim 17, further comprising:
generating a likelihood of availability of the location, wherein the likelihood of availability is based on one or more of traffic volume in proximity to the location, a time of day, a time of year, and a distance of the second device from the location; and
providing the likelihood of availability of the location to the first device.

19. The method of claim 17, further comprising:
receiving vehicle information corresponding to a vehicle in which the second device is located, wherein the vehicle information includes a dimension of the vehicle;
wherein generating the identification of the location includes determining whether the vehicle can fit into the location.

20. The method of claim 19, further comprising determining a size of the location based on one or more of the satellite image and received sensor information.
